(19) United States
(12) Patent Application Publication
(10) Pub. No.: US 2006/0121334 A1
(43) Pub. Date: Jun. 8, 2006

(54) Fuel cell and/or electrolyzer and method for producing the same

(76) Inventors: Olav Finkenwirth, Munchen (DE); Erich Bittner, Ellingen (DE); Carola Schneider, Weissenburg (DE); Armin Diez, Lenningen (DE)

Correspondence Address: Pauley Petersen & Erickson, Suite 365, 2800 W. Higgins Road, Hoffman Estates, IL, 60195, US

(21) Appl. No.: 11/250,171

(22) Filed: Oct. 13, 2005

Related U.S. Application Data
(63) Continuation of application No. PCT/EP04/03892, filed on Apr. 13, 2004.

(30) Foreign Application Priority Data
Apr. 15, 2003 (DE) 103 17 361.7

(51) Int. Cl. H01M 4/86; H01M 8/12; C25B 11/00

(52) U.S. Cl. 429/44; 429/33; 204/297.01; 204/286.1

(57) ABSTRACT

A fuel cell and/or electrolyzer, and a method of producing a fuel cell and/or electrolyzer. The fuel cell and/or electrolyzer has an electrolyte layer, one side of which is in contact with a cathode layer and the other side of which is in contact with an anode layer. The anode layer is electrically and/or mechanically in contact with a first interconnector. In the area of a free side of the cathode layer a contacting device is arranged, which is connected in an electrically conductive and mechanically material-to-material and/or positive manner with a second interconnector as well as with the cathode layer.

### RELATED APPLICATION

This application is a continuation of PCT Patent Application No. PCT/EP2004/003892, filed 13 Apr. 2004, which claims priority to German Patent Application No. 103 17 361.7, filed 15 Apr. 2003. The disclosure of the prior applications is incorporated herein by reference.

### BACKGROUND OF THE INVENTION

The invention relates to a fuel cell and/or an electrolyzer in accordance with the preamble of claim 1, as well as to a method for producing the same in accordance with the preamble of claim 21.

It is known from the prior art that, because of the low voltage which a single fuel cell is capable of providing, for technical applications, several cells must be switched together in series into a stack of fuel cells (English: stack). The electrical connection takes place via so-called interconnectors or bipolar plates. In the case of a planar stack structure, besides the electrical connection of the individual cells, the bipolar plates take on the additional task of the supply of combustion and oxide gas to the electrodes of the fuel cells, as well as the separation of the combustion and oxide gases of adjoining cells.

The bipolar plates are connected, material-to-material, with a metallic substrate of vacuum plasma-sprayed solid electrolyte fuel cells (so-called solid oxide fuel cells=SOFC), for example by brazing, capacitor discharge welding, rolled bead welding, or the like. A connection of low impedance between bipolar plates and the ceramic anode of the solid electrolyte fuel cell is assured by means of this.

Customarily the ceramic cathode of the solid electrolyte fuel cell is non-positively connected with the bipolar plate. This connection has a clearly greater contact resistance than the material-to-material connection on the anode side. Added to this is that, because of the low flexibility of the bipolar plate and the solid electrolyte fuel cell, unevenness of the surface on account of manufacturing tolerances can only be compensated by very strong contact pressure forces, which in turn can lead to mechanical damage of the delicate ceramic layers of the solid electrolyte fuel cell.

For improving the electrical contact of the cathode, and for compensating manufacturing tolerances, for example roughness or waviness of the surface, at the same time, a deformable ceramic suspension is applied to the assembly of the solid electrolyte fuel cell stack between the cathode and the adjoining bipolar plate prior, for example by a screen-printing or wet powder spraying method. This suspension dries and solidifies during the first operation of the fuel cell stack and constitutes a porous functional layer. However, a complete sintering of the functional layer with the cathode does not occur in the course of this, since the customary operating temperatures of the solid electrolyte fuel cell, which lie in the range between 750° C. and 900° C., and therefore below the sintering temperature of the material used, which is approximately 1400° C.

The non-positive connection of a bipolar plate and a solid electrolyte fuel cell cathode created in this way has the following disadvantages:

1. A conflict in goals is created in the course of optimizing the thickness of the functional layer: in order to be able to permit as large as possible manufacturing tolerances of the solid electrolyte fuel cells and the bipolar plates, it is necessary to make the functional layer relatively thick. Moreover, the thickness of the functional layer determines the electrical resistance, which is caused by the transverse guidance of the current in the functional layer to the closest current user of the bipolar plate, for example strips of a conduit structure. (In this connection see FIG. 4, which will be described in greater detail below). Moreover, in spite of its porosity, a thick functional layer represents a large oxygen transport resistance toward the cathode, and in this way reduces the electrical output of the cell.

2. Since the functional layer is not being sintered either to the bipolar plate or the cathode, the connection between the bipolar plate and the cathode provides only little strength and has hardly any mechanical flexibility. In particular in connection with a cyclic use with frequent and rapid temperature changes, such as occur in particular in connection with the mobile use of a solid electrolyte fuel cell as an auxiliary energy supply unit in a motor vehicle, this can lead to the failure of the functional layer in the form of high electrical contact resistances at the connecting faces between the metallic bipolar plate and the ceramic function layer.

Such a solid electrolyte fuel cell from the prior art is shown in a detailed plan view in FIG. 4, in which the layered structure in the area of a cathode and an adjoining interconnector plate is represented. A cathode layer 100 of a solid electrolyte fuel cell in accordance with the prior art is provided with a functional layer 102 for making contact with an adjoining interconnector, or bipolar plate 101, wherein the functional layer 102 is intended to cause a mechanical connection between the cathode 100 and the interconnector plate 101, as well as an electrical connection between the cathode 100 and the interconnector plate 101. Customarily, interconnector plates have conduits 103, in which oxidation gas, for example atmospheric oxygen, is transported, wherein the atmospheric oxygen picks up electrons at the cathode 100 in a known manner, so that a current flow from the cathode 100 to an anode (not represented) of the solid electrolyte fuel cell takes place. The current flow is schematically represented by the arrows 104 in FIG. 4. A solid electrolyte fuel cell structure in accordance with the prior art in FIG. 4 furthermore has the disadvantage that the current paths which are represented by the arrows 104 each extend inside the cathode layer 100 through the functional layer 102 to a strip 105, which separates conduits 103. This current flow which, depending on the design of the strips 105, is locally higher, provides an uneven utilization of the cathode layer 100 and a locally uneven stress, higher in areas, of the cathode layer 100 and the functional layer 102. This is disadvantageous and can lead to thermal stresses in the layers because of locally different heating.

A high-temperature fuel cell is known from DE 198 36 531 A1, in which a nickel net is arranged between the anode and the bipolar plate located next to the anode, wherein the nickel net has been fastened, electrically conductive, on the bipolar plate by means of metallic soldering. A fuel cell in accordance with DE 198 36 351 A1 also has the above mentioned disadvantages, since the connection of the interconnector plate to the anode is provided non-positively.

A high-temperature fuel cell, or a high-temperature fuel cell stack, and a method for producing them are known from DE 42 37 602 A1, wherein a functional layer is provided between each of the electrodes and the respectively adjoining bipolar plates, and wherein the functional layer is electronically conductive and easily deformable at the operating temperature of the stack. A high-temperature fuel cell described in DE 42 37 602 A1 substantially corresponds to the prior art described at the outset.

A device for bringing electrodes of high-temperature fuel cells into contact is known from DE 43 40 153 C1. In essence, this device is designed in the form of an electrically conductive, elastic and gas-permeable contact cushion with a deformable surface structure. During the operation of the fuel cell, this device merely rests in a non-positive manner against the adjoining separator plate and the electrode to be contacted, so that this device can also not prevent the above mentioned disadvantages.

A fuel cell module and a method for producing it is known from DE 198 41 919 A1, wherein the anode is fastened on its assigned interconnector plate with the aid of solder, and the cathode is electrically connected with its assigned interconnector plate by means of a functional layer. Such a fuel cell also has the disadvantage of a lack of mechanical tensile strength between the cathode and its facing interconnector plate, because the ceramic function layer is not in a material-to-material contact with the cathode, so that tensile loads therefore can only be insufficiently transmitted.

A method for producing a contact layer on the cathode side of a fuel cell is known from DE 199 32 194 A1, wherein the contact layer between the cathode and an interconnector plate, or an interspersed protective layer, is provided, and the method essentially has the following steps:

1. Application of at least one type of the single carbonates of the end product of lanthanum-perovskite to the interconnector plate or the cathode in the form of powder, soldering the individual structural elements of the fuel cell under load and the generation of heat, wherein the single carbonates of the contact layer are initially calcinized and the oxide phase of the lanthanum-perovskites are simultaneously sintered to form the contact layer. The fuel cell is cooled thereafter. Thus, one side of the contact layer to be produced in accordance with this publication is sintered together with the adjoining layer. By means of this the bonding with the bipolar plate, which can only be insufficiently stressed in the direction of pull, is again created, so that a fuel cell produced in this way disadvantageously shows an increased transfer resistance between the cathode and the assigned interconnector plate after some operating time. A mixture of single oxides and single carbonates, erroneously called solder in DE 199 32 194 A1, is cited as the connecting medium, which are reacted to form a lanthanum-perovskite by means of being heated and compressed. In this way a ceramic layer, made of the same material as is used for producing a cathode, is created as the connecting layer. In the course of creating a fuel cell stack by joining, a connecting layer between the cathode and a protective layer is created by means of a chemical calcination or sintering process, wherein intermediate products are created in the course of the chemical reaction, which have a different volume in comparison with the end products. This process is called soldering in DE 199 32 194 A1. However, this does not agree with the commonly accepted definition of a soldered connection. In accordance with Dubbel, 16th edition, page G20, 1.2.1, a soldered connection is defined as the connection of heated metals, which remain in the solid state, by means of melting metallic additional materials (solders). A chemical reaction of the solder does not take place here. To this extent the “soldering” in accordance with DE 199 32 194 A1 only has the heating of the components to be connected in common with term soldering in accordance with the definition.

It is furthermore disadvantageous in connection with a fuel cell in accordance with DE 199 32 194 A1 that the contact layer being created is a ceramic contact layer, which delicately reacts to mechanical tensions. The mechanical tensions can be created in a solid electrolyte fuel cell operating as a high temperature fuel cell, for example, because of different thermal expansion of the layers present in the fuel cell stack. The ceramic contact layer in accordance with DE 199 32 194 is characterized by sensitivity to brittle fracturing, so that damage to the contact layer, and therefore a worsening of the electrical transfer resistance between a cathode and an associated interconnector plate, can already occur even in case of a slight mechanical deformation.

It is an object of the invention to disclose a fuel cell and/or an electrolyzer which is resistant to high mechanical and thermal alternating loads, and furthermore has a high electrical output density. It is moreover intended to disclose a method for producing a fuel cell and/or electrolyzer which can be simply and cost-effectively performed. The method is intended in particular to be suitable for industrial scale manufacturing.

### SUMMARY OF THE INVENTION

In accordance with the invention, an air-permeable metallic contact element is applied by material-to-material contact, for example by brazing, laser soldering or resistance welding, to the side of the bipolar plate which provides the electrical connection with the cathode of the adjoining solid electrolyte fuel cell. The metallic contact element can be, for example, a knit, plaited or woven material, or a perforated metal foil. It has the purpose, together with a functional layer, of providing an electric contact with the cathode. Even at the operating temperature of the solid electrolyte fuel cell the contact element should still have a certain elasticity, i.e. a certain spring effect, in a direction perpendicularly in respect to the level of the solid electrolyte fuel cell layers, in order to maintain the required contact pressure against the cathode over the entire contact surface, even after many temperature cycles. Therefore the contact element can be designed specially structurally, for example provided with a wave or conduit structure. Moreover, defined properties of the material can be utilized, such as the elastic temper, for example. Moreover, the thermal expansion coefficient of the metal used for the contact element is preferably matched to the one of the bipolar plates and of the ceramic solid electrolyte fuel cell layers. It is possible by means of a variation of mesh width, looping and twisting angle, as well as the wire diameter of the contact element, to install lateral, as well as perpendicular density gradients in the contact element in the direction toward the fuel cell, which allow the optimization of the oxygen transport.

A further embodiment of the metallic contact element can be provided by the introduction of a second metallic phase. This second material can be distinguished by advantageous properties which the first phase does not, or only insufficiently, have, such as high electrical conductivity, catalytic activity and/or high spring elasticity, for example. It can be present either in the form of wires, fibers and/or surface coatings of the first phase.

Since the metallic contact element is exposed to a highly reactive oxidant at high temperatures, it is important that the metal used forms a stable, passivating surface. To prevent the oxide film from reducing the electrical current flow at the contact points of the wires with each other and at the boundary layer with the functional layer, the oxide film of the material used must have a sufficient electrical conductivity at operating temperature, i.e. it must be a so-called high temperature semiconductor.

The mentioned requirements are met, for example, by ferritic steel with a high chromium and low aluminum and silicon content. A small proportion of rare earth elements, such as yttrium or lanthanum, for example, improves the adhesiveness of the passivating oxide film on the surface of the wires.

A ceramic functional layer continues to be required between the metallic contact element and the cathode in addition to the contact element, because the electrical contact resistance between the metallic contact element and the ceramic cathode would be high because of the scant connection between the two materials, and the output of the solid electrolyte fuel cell would be reduced. Furthermore, the contact surface of the wire loops, for example when using a knit, woven or plaited material or the like, is low on the cathode surface in comparison with the entire contacted area. This would result in a local heating of the contact faces, in particular with high current flows, and therefore in a loss of electrical output.

Accordingly, a preferred embodiment of the invention therefore has a combination of a material-to-material contact of the metallic contact element with the bipolar plate and the application of a ceramic functional layer either to the cathode surface of the contact faces of the metallic contact element with the cathode. In the course of joining the fuel cell stack, the contact surface between the contact element and the cathode is thereby increased by a multiple. Various wet-ceramic coating processes are offered for applying the functional layer, such as screen printing technology, wet powder spraying or applicators with a displacement unit, for example. Ceramic materials from the group of perovskites can be considered to be functional layer materials, which are similar to the ceramic material of the cathode and therefore make possible good electrical contact because of the affinity of the materials. When selecting the materials it must be assured that no undesired chemical reactions with the material of the oxide films of the metallic contact element can occur.

Further preferred properties of the functional layer are a thermal expansion coefficient matched to the cathode and the metallic contact element, and an oxidation-reducing effect on the metal surface at the boundary layer between the contact element and the functional layer.

The combination in accordance with the invention, consisting of the “bipolar plate with an air-permeable metallic contact element connected in a material-to-material contact with it—functional layer—cathode” has the following advantages over the layer structure in accordance with the prior art of “bipolar plate—functional layer—cathode”:

1. Manufacturing tolerances of the bipolar plate and the solid electrolyte fuel cell are compensated during the joining of the stack by the elastic properties of the metallic contact element on the cathode side and the plastic deformability of the still viscous functional layer.

2. Because of the spring elasticity of the metal contact element remaining at operating temperature which, if desired, can be increased by adding a second material with improved mechanical properties, a sufficiently high contact pressure of the contact element on the cathode, or the functional layer, can still be assumed, even after many thermal operating cycles of a solid electrolyte fuel cell, in particular if used as an auxiliary energy supply unit.

3. The structure of the metallic element can be designed in such a way that the number of contact points with the functional layer is high, and the distance between the individual contact points is clearly less than in comparison with the prior art, in which the functional layer would directly contact a conduit structure necessarily existing in the bipolar plate. This leads to an improved, more finely structured mechanical interlacing of metallic and ceramic components of the solid electrolyte fuel cell.

4. Optimization of the air distribution over the cell surface can be realized in a simple manner by means of an embossed conduit structure, as well as a graduated structure of the contact element.

5. The previously mentioned shortening of the distances between the contact points of the metallic contact element and the functional layer also causes a shortening of the current conduction paths in the functional layer. By means of this it is possible to clearly reduce the required electrical cross section, and therefore the thickness of the functional layer applied by a wet-ceramic process, which in turn leads to a reduction of the oxygen transport resistance through the functional layer to the cathode, and therefore also to an increase of the electrical output of the solid electrolyte fuel cell.

6. In principle, the functional layer cannot only be applied to the cathode, but also to the metallic contact element. For this, application methods such as dipping, rolling, can be employed. An advantage of this variation is that a lesser coverage of the surface of the cathode by the functional layer can be realized, and therefore an again reduced oxygen transport resistance to the cathode.

7. The combination of two contact elements of, on the one hand, a flexible metallic contact element, and also of a functional layer cured under operating conditions, makes possible a division of labor of the two elements. The metallic component takes on the compensation of manufacturing tolerances and the making available of a sufficient contact pressure force on the functional layer, while the functional layer can be optimized in regard to the lowering of the electrical contact resistance between the metallic component and the cathode.

### BRIEF DESCRIPTION OF THE DRAWINGS

The invention will be explained in greater detail by way of example in what follows by means of the drawings. Shown are in:

FIG. 1, a schematic cross section through a fuel cell stack with individual fuel cells in accordance with the invention.

FIG. 2, an enlarged detailed plan view X from FIG. 1 of a contact in accordance with the invention of a cathode with an adjoining bipolar plate.

FIG. 3, a schematic further detailed plan view of an interconnector plate, a contacting device and a cathode layer of a solid electrolyte fuel cell in accordance with the invention.

FIG. 4, a layer structure of a solid electrolyte fuel cell in accordance with the prior art in a schematic detail plan view.

### DESCRIPTION OF PREFERRED EMBODIMENTS

In what follows, the invention will be explained by way of example by means of the description of a fuel cell. Of course, all statements correspondingly apply to the operation of the fuel cell in accordance with the invention as an electrolyzer.

A fuel cell stack 1 (FIG. 1) has several individual fuel cells 2. The individual fuel cells 2 have an electrolyte layer 3, an anode layer 4 and a cathode layer 5, which are designed in a known manner in the form of a solid electrolyte fuel cell (SOFC). The anode layer 4 is constructed as a ceramic-metal composite material (English: cermet=ceramic and metal), and consists for example of nickel and zirconium dioxide. Customarily, the electrolyte layer 3 consists of yttrium-stabilized zirconium oxide. The cathode layer 5 customarily consists, for example, of ceramic lanthanum-strontium-manganese oxide (LSM), which often is additionally mixed with yttrium-stabilized zirconium oxide (YSZ). In the drawings, the anode layer 4 is represented thicker than the electrolyte layer 3 and the cathode layer 5. The anode layer 4 is possibly arranged on a mechanically supportive substrate layer (not represented). By means of a free side 6 located opposite the electrolyte layer 3, the anode layer 4, or the substrate layer, is connected with a first interconnector 7. The first interconnector 7 is constructed substantially plate-shaped from a metal and has a first flat side 8 and a second flat side 9. Both flat sides 8 and 9 have gas conduits 10 and 11 in the area of the electrically active layers 3, 4, 5, wherein the gas conduits 10 which are arranged in the area of the first flat side 8 are combustion gas conduits facing the anode layer 4. The gas conduits 11, which face a cathode layer 5 in the area of the second flat side 9, conduct an oxidation gas required for the oxidation of the combustion gas, for example atmospheric oxygen, during the operation of the fuel cell. Each of the gas conduits 10 are separated from each other by strips 12, the gas conduits 11 by strips 13. With its free side 6, the anode layer 4 is connected, electrically conducting and preferably mechanically connected material-to-material, with free ends of the strips 12 of the first interconnector 7. The anode layer 4, or the substrate layer, is connected with the first interconnector 7, for example by brazing, by capacitor discharge welding, or by laser soldering, or by rolled bead welding or like types of material-to-material connection.

A contacting device 21 is arranged on a free side 20 of the cathode layer 5 located opposite the electrolyte layer 3. The contacting device 21 is substantially constructed in the shape of layers and is, for example, a knit material, a net or a perforated sheet metal plate. The contacting device 21 is also made of an electrically conductive material, which moreover is embodied to be elastic in a direction 22 perpendicularly to the layer levels of the electrolyte layer 3, the anode layer 4, the cathode layer 5 and the contacting device 21. Thus, the contacting device 21 is preferably embodied as a metallic wire knit material, metallic wire net, metallic wire wool material or perforated metal foil, which in particular is resiliently compressible.

In accordance with a preferred embodiment, the conduits 10 and 11 in the interconnector 7 can be omitted. In this case the gas-permeable contacting device 21 provides the gas supply or the removal of the reaction product.

The contacting device 21 is designed as an air-permeable, porous, flexible, metallic structure. It is made of a metal which forms a stable passivating surface, whose oxide film reduces the electric current flow at the contact points between the metallic contacting device 21 and the cathode layer 5 and a second interconnector 30 as little as possible. For this purpose the oxide film of the metal used must have a sufficient electrical conductivity at an operating temperature of the solid electrolyte fuel cell, which customarily lies in the range above 7000C, i.e. it must be a mentioned high-temperature semiconductor. These requirements are met, for example, by ferritic steel with a high chromium and low aluminum content. A small number of rare earth elements, such as yttrium or lanthanum, for example, improve the adhesiveness of the passivating oxide film to the surface of the material constituting the contacting device 21.

A free flat side of the contacting device 21, which is embodied as a layer, is in an electrically conductive and mechanical material-to-material connection with the second interconnector 30 of an adjoining individual fuel cell 2. A mechanical material-to-material connection 31 between the contacting device 21 and the second interconnector 30 is embodied, for example, in the form of brazing, capacitor discharge welding or laser soldering, or like type of fastening.

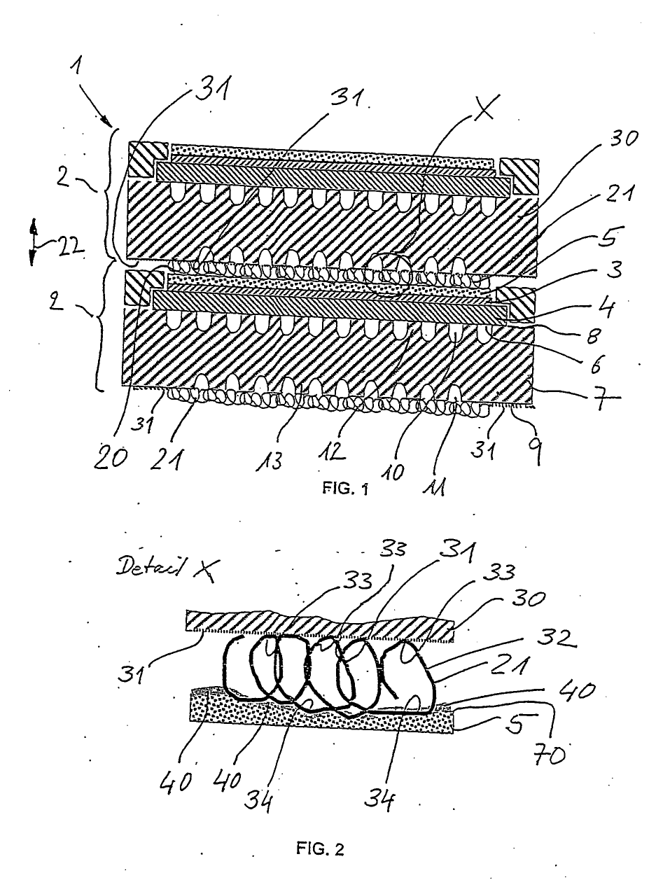

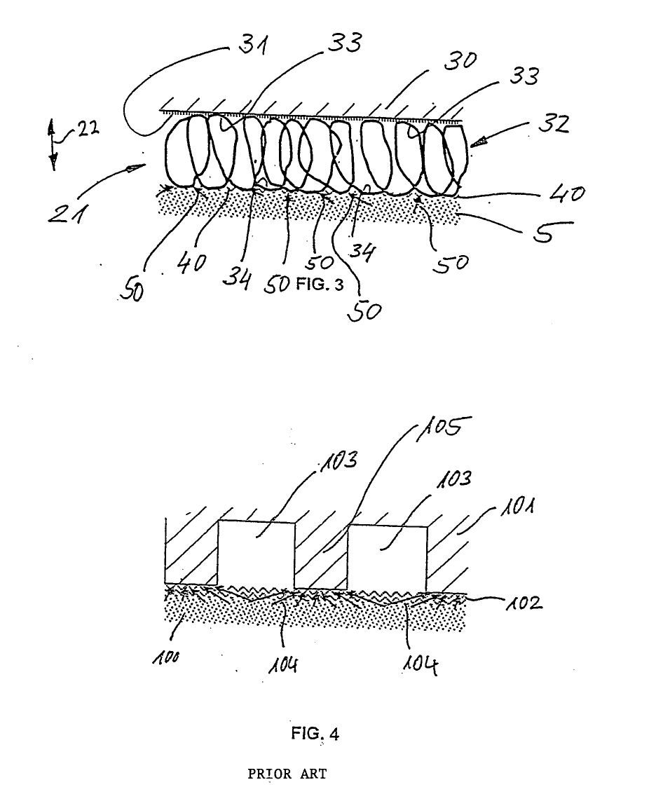

In what follows, the material-to-material bond between the cathode layer 5 and the second interconnector 30 by means of the connecting device 21 will be explained in greater detail by way of example by means of the detail from FIG. 1, represented in FIG. 2.

By way of example, the contacting device 21 in FIG. 2 is embodied as a wire wool material in the form of a thin metal wire 32, wherein curved metal wire sections 33 face the second interconnector 30 and curved metal wire sections 34 of the contacting device 21 face the cathode layer 5. The curved metal wire sections 33 are connected by means of the material-to-material connection 31 with the second interconnector 30, wherein the curved metal wire sections 33, for example, are embedded in a layer of the material-to-material connection 31 and in this way are solidly connected with the second interconnector 30, in particular fixed against pull in a direction 22.

The curved metal wire sections 34 facing the cathode layer 5 are connected by means of a connecting layer 40, in particular a ceramic one, which for one is connected in a material-to-material manner with the cathode layer 5, and furthermore in a material-to-material or a positive manner with the contacting device 21.

The ceramic connecting layer 40 makes a particularly stable material-to-material connection with the oxide film of the contacting device 21.

The connecting layer 40 is preferably embodied as a ceramic connecting layer, wherein ceramic materials from the group of perovskites are preferably employed. The materials of the functional layer are similar to the ceramic cathode material and therefore assure, make possible, good electrical and mechanical contact because of the affinity of the materials. The selection of the materials for the functional layer is made in such a way that it is assured that no undesired chemical reactions with the material and with the possibly existing oxide films of the metallic contacting device 21 occur. It is furthermore advantageous to select a material for the connecting layer 40 which has a thermal expansion coefficient matched to that of the cathode layer 5 and the contacting device 21. The material of the connecting layer 40 preferably exerts an oxidation-resistant effect on the metal surface in the area of the boundary area between the contacting device 21 and the connecting layer 40.

In accordance with the invention, the curved metal wire sections 34 are embedded in a material-to-material and/or positively connected manner and are connected with a free surface 70 by means of the connecting layer 40. For one, this assures a high electrical conductivity between the cathode layer 5 and the contacting device 21, and furthermore assures a high degree of tensile load-carrying capability of the connection between the contacting device 21 and the cathode 5. Thus, the mechanical bond between the second interconnector 30 and an adjoining cathode layer 5 is assured under a tensile load via the contacting device 21, which is connected on the side of the second interconnector 30 by means of a material-to-material connection 31, and is connected on the side of the cathode layer 5 by means of a material-to-material connection 40 of the cathode layer 5. Therefore this is a combination of a material-to-material connection of the contacting device 21 with the interconnector 30, and a material-to-material and/or positive connection of the contacting device 21 with the cathode layer 5, and a material-to-material connection of a cathode layer 5 with a fuel cell 2.

The arrangement in accordance with the invention of an electrical contacting device 21 between an interconnector plate 30 and the connecting layer 40 has the advantage that, for one, the connecting layer 40 is sintered in a material-to-material connection to the cathode layer 5, and that it is furthermore possible to embed curved metal wires 34 in a material-to-material connected manner in the connecting layer 40, so that a connection which can be exposed to a tensile load in a direction 22 is formed.

By means of the construction in accordance with the invention of a solid electrolyte fuel cell (see FIG. 3), a contact of the cathode layer 5 by means of the contacting device 21 takes place at a multitude of contact locations, wherein the contact locations are distributed substantially evenly over the surface of the cathode layer 5. Each contact location constitutes a possible current guidance path 50 between the cathode layer 5 and the contacting device 21, so that the contact locations which are uniformly distributed over the surface can also cause a uniform distribution of the current guide paths over the surface. Such a uniform distribution of the current guide paths 50 over the surface has the advantage that, unlike in the prior art, the cathode layer 5 is not locally charged with higher current at defined locations, while no current flow can occur at other locations. This leads to a uniform use of the surface of the cathode layer 5 and therefore contributes to an increase in output of the solid electrolyte fuel cell in accordance with the invention.

In accordance with a particularly preferred embodiment it is possible to omit the conduits in the interconnector plate 30, if desired, since the oxidation gas supply is assured at a sufficiently high level by the porous, air-permeable design of the contacting device 21. Moreover, by means of layer arrangement in accordance with the invention it is achieved that the mechanical connection between the interconnector plate 30 and the cathode layer 5 via the material-to-material connection 31, the contacting device 21 and the material-to-material and/or positive connection 40 can also absorb tensile forces which can possibly arise during the extended operation of the fuel cell. Thus, a dependable electric contact of the interconnector plate 30 with the cathode layer 5 is also assured under such operational conditions.

The method in accordance with the invention for producing a fuel cell will be explained in greater detail in what follows: the sequence of the process steps selected hereinafter is not absolutely required for the chronological course of the production method. It is merely used for a representational description of the method and represents a possible, in particular preferred, sequence of the production steps.

First, in a substantially known manner the electro-chemical layer structure, consisting of anode layer 4, electrolyte layer 3 and cathode layer 5, for a high temperature solid electrolyte fuel cell is produced. In the customary way, this can take place by means of the vacuum plasma-spray production method, or by means of a sinter-ceramic production method by mixing a metallic-ceramic suspension and a subsequent sintering process for the respective layer. With the vacuum plasma spray production method, the layer structure of the individual layers 3, 4, 5 is produced by blowing-in the materials constituting the respectively forming layers in a plasma jet of a plasma torch, wherein the plasma torch is conducted in a meander shape, for example, over a substrate layer, so that a layered structure is achieved by the meander-shaped displacement of the plasma torch.

The composite of anode layer 4, electrolyte layer 3 and cathode layer 5 is connected on the anode side with a free flat side 8 of a first interconnector 7, wherein the connection is made electrically conductive and/or preferably in a mechanically material-to-material connected manner. Particularly suited for this are the fastening methods by brazing, capacitor discharge welding or laser soldering.

Fastening of the contacting device 21 to a second flat side 9 of a second interconnector 30 takes place preferably in the same way as the fastening of the anode layer 4 on the first interconnector 7, so that an electrically conductive, mechanically tension-resistant connection between the contacting device 21 and the associated second interconnector 30 is prepared.

A suitable ceramic suspension and/or a paste of a ceramic material constituting the connecting layer 40 is applied to a free surface 70 of the cathode layer 5, in particular by means of so-called wet application techniques, for example screen printing, wet powder spraying, and the like, wherein the application of the material constituting the connecting layer 40 takes place prior to the assembly process of the fuel cell stack 1. In the same way, in accordance with a further embodiment of the method of the invention it is of course possible to apply the material constituting the connecting layer 40 to the free side of the contacting device 21 located opposite the interconnector plate 30 by rolling or coating the contacting device 21, as well as by dipping the free side of the contacting device 21.

In the course of assembling the fuel cell stack 1, the second interconnector 30, together with the contacting device 21 bonded to it, is then placed on the free side 20 of the cathode layer, or on the prepared connecting layer 40, so that the contacting device 21 enters into the connecting layer 40.

Thus, the previously applied connecting layer 40 is located between the curved metal wire sections 34 of the contacting device 21 and the cathode layer 5. In a particularly preferred way a point-by-point or partial area arrangement of the connecting layer 40 can take place in such a way that the basic material of the connecting layer, i.e. the suspension and/or the paste, is applied to the side of the contacting device 21 facing the cathode layer 5, wherein it is assured that the materials constituting the connecting layer 40 are only applied in those areas of the contacting device 21 which are later intended to come into contact with the cathode layer 5. This can be assured, for example, by means of a beam-like application method, wherein only the protruding areas of the contacting device 21 are wetted, coated, or the like, with the material constituting the connecting layer 40.

Following the assembly of the fuel cell stack 1, the ceramic materials of the cathode 5 and the connecting layer 40 are sintered together, so that a mechanical bond is formed, which resists tensile forces. To this end, the fuel cell stack 1 is subjected to a temperature clearly above the customary operating temperature of the fuel cell stack 1, so that the sintering of these materials dependably takes place.

In accordance with a preferred embodiment, in addition to the ceramic material constituting the connecting layer 40, a second ceramic functional layer is inserted which, by means of its structure and/or the addition of so-called sintering aides, causes a lowering of the required sintering temperature. The second functional layer (not represented) can be applied by means of wet-ceramic coating methods, such as screen printing, wet powder spraying or applicators with a displacement unit, for example.

It is particularly advantageous in connection with the fuel cell of the invention, or the electrolyzer of the invention, as well as the method of the invention for its/their production, that each individual fuel cell enters into a bond with an adjacent fuel cell which can absorb tensile forces in a direction opposite the assembly direction of the fuel cell stack. By means of this an electrical contact of the cathode with the adjoining interconnector is assured which is of high quality also over a long time. Moreover, by means of the method in accordance with the invention a production method is provided, which can be performed in an easy manner and can be applied in particular in the field of industrial scale manufacturing. At the same time, a fuel cell in accordance with the invention has an increased electrical output density since, by means of the embodiment in accordance with the invention of the material-to-material connection between the contacting device 21 and the cathode layer 5, free surface sections 70a of the free surface 70 are formed, which are not covered by the connecting layer 40 and therefore do not interfere with the diffusion of the oxygen ions through the cathode in any way.

1. A fuel cell and/or electrolyzer with an electrolyte layer, one side of which is in contact with a cathode layer and the other side of which is in contact with an anode layer, and the anode layer is electrically and/or mechanically in contact with a first interconnector, and in the area of a free side of the cathode layer a contacting device is arranged, which is connected in an electrically conductive and mechanically material-to-material and/or positive manner with a second interconnector as well as with the cathode layer.

2. The fuel cell and/or electrolyzer in accordance with claim 1, wherein the connection between the cathode layer and the contacting device is a ceramic connecting layer.

3. The fuel cell and/or electrolyzer in accordance with claim 1 wherein the mechanical material-to-material connection between the contacting device and the second interconnector is embodied to be a material-to-material connection selected from the group consisting of a capacitor discharge weld, a rolled bead weld, and a brazing point.

4. The fuel cell and/or electrolyzer in accordance with claim 2, wherein the ceramic connecting layer is formed of ceramic materials, in particular from the group of perovskites.

5. The fuel cell and/or electrolyzer in accordance with claim 1, wherein the anode layer is constructed of a ceramic-metal composite material and consists of nickel and zirconium dioxide, for example.

6. The fuel cell and/or electrolyzer in accordance with claim 1, wherein the electrolyte layer consists of a ceramic material, for example an yttrium oxide-stabilized zirconium oxide.

7. The fuel cell and/or electrolyzer in accordance with claim 1, wherein the cathode layer comprises ceramic lanthanum-strontium-manganese oxide (LSM) which, if desired, is additionally mixed with yttrium-stabilized zirconium oxide (YSZ).

8. The fuel cell and/or electrolyzer in accordance with claim 1, wherein the anode layer is applied to a mechanically supporting metallic or ceramic substrate layer.

9. The fuel cell and/or electrolyzer in accordance with claim 1, wherein a free side of the anode layer located opposite the electrolyte layer is connected with a first interconnector.

10. The fuel cell and/or electrolyzer in accordance with claim 9, wherein the interconnector is embodied to be free of gas conduits.

11. The fuel cell and/or electrolyzer in accordance with claim 1, wherein the contacting device is gas-permeable.

12. The fuel cell and/or electrolyzer in accordance with claim 1, wherein the anode layer is connected with the first interconnector by one of the group consisting of brazing, capacitor discharge welding, laser soldering, and rolled bead welding.

13. The fuel cell and/or electrolyzer in accordance with claim 1, wherein the contacting device is arranged on the free side of the cathode layer located opposite the electrolyte layer, wherein the contacting device is embodied substantially in the shape of layers and is selected from the group consisting of a knit material, net, and a perforated sheet metal plate.

14. The fuel cell and/or electrolyzer in accordance with claim 1, wherein the contacting device is made of an electrically conductive material, and the contacting device is designed to be elastic in a direction perpendicular to the layer levels of the electrolyte layer, the anode layer, the cathode layer and the contacting device.

15. The fuel cell and/or electrolyzer in accordance with claim 1, wherein the contacting device is designed as a resiliently compressible metallic wire knit material, metallic wire net or metallic wire wool material.

16. The fuel cell and/or electrolyzer in accordance with claim 1, wherein the contacting device is made of a metal which forms a stable passivating surface.

17. The fuel cell and/or electrolyzer in accordance with claim 16, wherein an oxide film of the metal is a high-temperature semiconductor.

18. The fuel cell and/or electrolyzer in accordance with claim 1, wherein the contacting device is made of ferritic steel with a high chromium and low aluminum content, as well as a small proportion of rare earth elements, if desired, such as yttrium or lanthanum.

19. The fuel cell and/or electrolyzer in accordance with claim 1, wherein the contacting device is made of a thin metal wire, wherein curved metal wire sections and curved metal wire sections are connected with the adjoining layers in a material-to-material and/or positively connected manner and are tension-resistant in one direction.

20. The fuel cell and/or electrolyzer in accordance with claim 1, wherein the contacting device is connected only in areas with the cathode layer, in particular in areas where metallic particles protrude from the cathode surface.

21. A method for producing a fuel cell and/or an electrolyzer, having an electrolyte layer, an anode layer and a cathode layer, comprising connecting the anode layer, electrically conducting and/or mechanically, with a first interconnector, and connecting a contacting device in an electrically conductive and mechanical material-to-material and/or positively connected manner with the cathode layer, as well as with a second interconnector.

22. The method in accordance with claim 21, wherein a ceramic connecting layer is employed for the electrically conductive and mechanical material-to-material and/or positive connection of the connecting device with the cathode layer.

23. The method in accordance with claim 21, comprising connecting a composite of the anode layer, the electrolyte layer and the cathode layer is connected at the anode side with a free flat side of a first interconnector, wherein the connection is embodied to be electrically conductive and/or mechanically connected material-to-material.

24. The method in accordance with claim 21, wherein the connection between the anode layer and the first interconnector is provided by means one of the group consisting of brazing and/or by means of capacitor discharge welding, and laser soldering.

25. The method in accordance with claim 21, wherein the connection of the contacting device with a second interconnector is provided by one of the group consisting of brazing, capacitor discharge welding, and laser soldering.

26. The method in accordance with claim 22, wherein the connecting layer for assembling the fuel cell and/or the electrolyzer is applied to a free side of the cathode using a wet application technique, for example as a paste.

27. The method in accordance with claim 22, wherein the connecting layer for assembling the fuel cell and/or the electrolyzer is applied to at least a partial area of a free side of the contacting device.
